(19) United States
(12) Patent Application Publication
(10) Pub. No.: US 2025/0346756 A1
(43) Pub. Date: Nov. 13, 2025

(54) RESIN COMPOSITION

(71) Applicant: NAN YA PLASTICS CORPORATION, Taipei City (TW)

(72) Inventors: Ching-Yao Yuan, Taipei City (TW); Yi-Je Tsai, Taipei City (TW); Li Yun Chen, Taipei City (TW); Hung-Yi Chang, Taipei City (TW); Chia-Lin Liu, Taipei City (TW)

(73) Assignee: NAN YA PLASTICS CORPORATION, Taipei City (TW)

(21) Appl. No.: 18/676,373

(22) Filed: May 28, 2024

(30) Foreign Application Priority Data
May 8, 2024 (TW) 113116986

(51) Int. Cl. C08L 71/12; C08K 3/34; C08K 5/14

(52) U.S. Cl. CPC C08L 71/123; C08K 3/34; C08K 5/14; C08L 2203/20; C08L 2205/035

(57) ABSTRACT

A resin composition includes a base resin and a hardened resin. The base resin includes a polyphenylene ether resin, a vinyl copolymer, and an olefinic resin. A weight proportion of the base resin in the resin composition is between 15 wt % and 25 wt %. A weight proportion of the hardened resin in the resin composition is between 5 wt % and 15 wt %.

### CROSS-REFERENCE TO RELATED APPLICATION

This application claims the priority benefit of Taiwan application serial no. 113116986, filed on May 8, 2024. The entirety of the above-mentioned patent application is hereby incorporated by reference herein and made a part of specification.

### BACKGROUND OF THE INVENTION

### Field of the Invention

The invention relates to a resin composition.

### Description of Related Art

In recent years, with the rapid development of integrated circuit (IC) techniques, the requirements for wiring density (L/S) and transmission rate of chips (such as high-speed computing chips) have increased. Moreover, in order to be more suitable for applications in high-frequency and fast transmission fields, the requirements for low dielectric properties of resin compositions are also increasing.

### SUMMARY OF THE INVENTION

The invention provides a resin composition with optimized electrical performance.

A resin composition of the invention includes a base resin and a hardened resin. The base resin includes a polyphenylene ether resin, a vinyl copolymer, and an olefinic resin. A weight proportion of the base resin in the resin composition is between 15 wt % and 25 wt %. A weight proportion of the hardened resin in the resin composition is between 5 wt % and 15 wt %.

In an embodiment of the invention, the polyphenylene ether resin includes a methacrylate polyphenylene ether resin, an oligophenylene ether, or a combination thereof, the vinyl copolymer includes a butadiene-styrene copolymer, and the olefinic resin includes an allylated phenol resin.

In an embodiment of the invention, the hardened resin includes an allyl resin having an isocyanuric acid ring, a maleimide resin, or a combination thereof.

In an embodiment of the invention, the hardened resin adopts only an allyl resin having an isocyanuric acid ring.

In an embodiment of the invention, a weight proportion of the olefinic resin in the base resin is between 10 wt % and 35 wt %, a weight proportion of the polyphenylene ether resin in the base resin is between 40 wt % and 70 wt %, and a weight proportion of the vinyl copolymer in the base resin is between 20 wt % and 25 wt %.

In an embodiment of the invention, the resin composition further includes an initiator. A weight proportion of the initiator in the resin composition is between 0.1 wt % and 0.2 wt %.

In an embodiment of the invention, the resin composition further includes an inorganic filler material. A weight proportion of the inorganic filler material in the resin composition is between 60 wt % and 80 wt %.

In an embodiment of the invention, a weight proportion of the polyphenylene ether resin in the base resin is greater than a weight proportion of the olefinic resin in the base resin and a weight proportion of the vinyl copolymer in the base resin.

In an embodiment of the invention, a sum of a weight proportion of the polyphenylene ether resin in the base resin, a weight proportion of the vinyl copolymer in the base resin, and a weight proportion of the olefinic resin in the base resin is 100 wt %.

In an embodiment of the invention, a usage amount of the hardened resin in the resin composition is greater than a usage amount of the olefinic resin in the resin composition.

Based on the above, in the invention, the olefinic resin is introduced into the resin system including the polyphenylene ether resin and the vinyl copolymer, and the small amount of functional groups in the olefinic resin reduces the overall dielectric properties. In this way, the electrical performance of the resin composition may be optimized.

In order to make the aforementioned features and advantages of the disclosure more comprehensible, embodiments accompanied with figures are described in detail below.

### DESCRIPTION OF THE EMBODIMENTS

In the following detailed description, for purposes of illustration and not limitation, exemplary embodiments disclosing specific details are set forth in order to provide a thorough understanding of the various principles of the invention. It will be apparent, however, to one of ordinary skill in the art, having the benefit of this disclosure, that the invention may be practiced in other embodiments that depart from the specific details disclosed herein.

Unless otherwise stated, the term “between” used in this specification to define numerical ranges is intended to cover ranges equal to and between the stated endpoints. For example, if a size range is between a first value and a second value, it means that the size range may cover the first value, the second value, and any value between the first value and the second value.

Unless otherwise defined, all terms (including technical and scientific terms) used herein have the same meaning as commonly understood by those skilled in the art to which this invention belongs.

In the present embodiment, a resin composition includes a base resin and a hardened resin (can be regarded as a hardener), wherein the weight proportion of the base resin in the resin composition is between 15 wt % and 25 wt %, and the weight proportion of the hardened resin in the resin composition is between 5 wt % and 15 wt %. Furthermore, the base resin includes a polyphenylene ether resin, a vinyl copolymer, and an olefinic resin. Accordingly, in the invention, the olefinic resin is introduced into the resin system including the polyphenylene ether resin and the vinyl copolymer, and the small amount of functional groups in the olefinic resin reduces the overall dielectric properties. In this way, the electrical performance of the resin composition may be optimized.

In some embodiments, the polyphenylene ether resin includes a methacrylate polyphenylene ether resin, an oligophenylene ether, or a combination thereof, the vinyl copolymer includes a butadiene-styrene copolymer, and the olefinic resin includes an allylated phenol resin, but the invention is not limited thereto.

In some embodiments, the vinyl copolymer includes a hydrogenated product of a styrene-butadiene copolymer to achieve better electrical properties, but the invention is not limited thereto.

In some embodiments, the hardened resin includes an allyl resin having an isocyanuric acid ring, a maleimide resin, or a combination thereof, wherein when the hardened resin adopts only an allyl resin having an isocyanuric acid ring, better performance is achieved in low dielectric properties, but the invention is not limited thereto.

In some embodiments, the weight proportion of the olefinic resin in the base resin is between 10 wt % and 35 wt %, the weight proportion of the polyphenylene ether resin in the base resin is between 40 wt % and 60 wt %, and the weight proportion of the vinyl copolymer in the base resin is between 20 wt % and 25 wt % to achieve better electrical specifications, but the invention is not limited thereto.

In some embodiments, the weight proportion of the polyphenylene ether resin in the base resin is greater than the weight proportion of the olefinic resin in the base resin and the weight proportion of the vinyl copolymer in the base resin, but the invention is not limited thereto.

In some embodiments, the sum of the weight proportion of the polyphenylene ether resin in the base resin, the weight proportion of the vinyl copolymer in the base resin, and the weight proportion of the olefinic resin in the base resin is 100 wt %. That is, the base resin only includes the polyphenylene ether resin, the vinyl copolymer, and the olefinic resin, but the invention is not limited thereto.

In some embodiments, the usage amount of the hardened resin in the resin composition is greater than the usage amount of the olefinic resin in the resin composition, but the invention is not limited thereto.

In some embodiments, the resin composition further includes an initiator, wherein the weight proportion of the initiator in the resin composition is between 0.1 wt % and 0.2 wt %. For example, the initiator includes 1,3-bis(butylperoxyisopropyl)benzene, but the invention is not limited thereto and other suitable peroxides may also be adopted.

In some embodiments, the resin composition further includes an inorganic filler material, wherein the weight proportion of the inorganic filler material in the resin composition is between 60 wt % and 80 wt %. For example, the inorganic filler material includes silicon oxide, but the invention is not limited thereto and other suitable fillers may also be adopted.

It should be noted that the resin composition may be regarded as a non-volatile component in the resin composition (varnish-like) dissolved in the solvent, and when the non-volatile component is 100 wt %, the content of the inorganic filler material is greater than or equal to 70 wt %, but the invention is not limited thereto. Moreover, the resin composition of the invention may be processed into a prepreg and a copper foil substrate (CCL) according to actual design requirements, and the specific implementations listed above are not limitations of the invention.

The following examples and comparative example are given to illustrate the effects of the invention, but the patent scope of the invention is not limited to the scope of the examples.

The products of each Example and Comparative example were evaluated according to the following method.

Dielectric constant Dk, dielectric loss Df: the above resin films were heated at 200° C. for 90 minutes to form cured films. The cured films were cut into a size of 10 mm in length and 7 mm in width. According to the standard test method of IPC-TM-650 (method 2.5.5.3), the dielectric constant (Dk, ε r) and the dielectric loss (dissipation factor, Df, Tan δ) of the material under a 10 GHz signal were measured.

Coefficient of thermal expansion (CTE) (x-y plane direction): using a thermomechanical analyzer (TMA), the coefficient of thermal expansion, that is, X-Y CTE (ppm/° C.) of the material in the X-Y plane was measured according to the standard test method of IPC-TM-650 2.4.24. The temperature rising range condition of the test was 40° C. to 120° C.

Glass transition temperature (Tg) (° C.): the glass transition temperature Tg (° C.) of the material was measured using a thermomechanical analyzer (TMA) according to the standard test method of ASTM E1545.

### Examples 1 to 6, Comparative Example 1

The resin compositions shown in Table 1 were dissolved in the solvent (toluene) to form liquid (varnish-like) resin compositions, and then the resin compositions were coated on the support (PET release film) using a mouth-mode coater. After drying to form film layers, properties such as dielectric constant, dielectric loss, coefficient of thermal expansion, glass transition temperature were evaluated. The results thereof are shown in Table 1. After comparing the results of Examples 1 to 6 and Comparative example 1 of Table 1, the following conclusions may be drawn: Example 1 to Example 6 having the olefinic resin indeed had better electrical performance (dielectric loss was less than 0.003). For example, the dielectric constant (Dk) of the preferred Example 1 may reach 2.7, the dielectric loss (Df) thereof may reach 0.0015, and the coefficient of thermal expansion thereof may reach 18.1 ppm/° C.

TABLE 1

| | | | | | | | | Comparative |
|---|---|---|---|---|---|---|---|---|
| | | Example | | | | | | example |
| | | 1 | 2 | 3 | 4 | 5 | 6 | 1 |
| Base resin | Olefinic resin (allylated | 6.86 | 6.86 | 6.86 | 2.99 | 2.99 | 2.99 | 0 |
| | phenol resin, LVA01) (parts | | | | | | | |
| | by weight) | | | | | | | |
| | Polyphenylene ether resin | 4.78 | 4.78 | 4.78 | 6.27 | 6.27 | 6.27 | 8.21 |
| | (methacrylate polyphenylene | | | | | | | |
| | ether resin, SA9000) (parts | | | | | | | |
| | by weight) | | | | | | | |
| | Polyphenylene ether resin | 4.78 | 4.78 | 4.78 | 6.27 | 6.27 | 6.27 | 8.21 |
| | (oligophenylene ether, | | | | | | | |
| | OPE1200) (parts by weight) | | | | | | | |
| | Vinyl copolymer (butadiene- | 2.39 | 2.39 | 2.39 | 5.37 | 5.37 | 5.37 | 4.48 |
| | styrene copolymer, Ricon | | | | | | | |
| | 100) (parts by weight) | | | | | | | |
| | Vinyl copolymer (butadiene- | 2.09 | 2.09 | 2.09 | 0 | 0 | 0 | 0 |
| | styrene copolymer, S1605) | | | | | | | |
| | (parts by weight) | | | | | | | |
| Hardened | Allyl resin having | 8.95 | 0 | 0 | 8.95 | 4.48 | 4.48 | 8.95 |
| resin | isocyanuric acid ring (L- | | | | | | | |
| | DAIC) (parts by weight) | | | | | | | |
| | Maleimide resin (MIR3000) | 0 | 8.95 | 0 | 0 | 4.47 | 0 | 0 |
| | (parts by weight) | | | | | | | |
| | Maleimide resin (MIR5000) | 0 | 0 | 8.95 | 0 | 0 | 4.47 | 0 |
| | (parts by weight) | | | | | | | |
| | Initiator (1,3- | 0.15 | 0.15 | 0.15 | 0.15 | 0.15 | 0.15 | 0.15 |
| | bis(butylperoxyisopropyl) | | | | | | | |
| | benzene, Perbutyl P) (parts | | | | | | | |
| | by weight) | | | | | | | |
| | Inorganic filler material | 70 | 70 | 70 | 70 | 70 | 70 | 70 |
| | (silicon oxide, SC2300-SVJ) | | | | | | | |
| | (parts by weight) | | | | | | | |

| | | | | | | | |
|---|---|---|---|---|---|---|---|
| Electrical properties (Dk/Df) | 2.7/0.0015 | 2.86/0.0024 | 2.85/0.0022 | 2.62/0.0014 | 2.81/0.0018 | 2.91/0.0016 | 3.82/0.039 |
| X-Y coefficient of thermal expansion | 18.1 | 26.6 | 26.7 | 23.2 | 25.6 | 27 | 25 |
| (40° C. to 120° C.) (ppm/° C.) | | | | | | | |
| Glass transition temperature (° C.) | 219 | 194 | 191 | 195 | 216 | 217 | 198 |

Based on the above, in the invention, the olefinic resin is introduced into the resin system including the polyphenylene ether resin and the vinyl copolymer, and the small amount of functional groups in the olefinic resin reduces the overall dielectric properties. In this way, the electrical performance of the resin composition may be optimized.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A resin composition, comprising:
a base resin comprising a polyphenylene ether resin, a vinyl copolymer, and an olefinic resin, wherein a weight proportion of the base resin in the resin composition is between 15 wt % and 25 wt %; and
a hardened resin, wherein a weight proportion of the hardened resin in the resin composition is between 5 wt % and 15 wt %.

2. The resin composition of claim 1, wherein the polyphenylene ether resin comprises a methacrylate polyphenylene ether resin, an oligophenylene ether, or a combination thereof, the vinyl copolymer comprises a butadiene-styrene copolymer, and the olefinic resin comprises an allylated phenol resin.

3. The resin composition of claim 1, wherein the hardened resin comprises an allyl resin having an isocyanuric acid ring, a maleimide resin, or a combination thereof.

4. The resin composition of claim 1, wherein the hardened resin adopts only an allyl resin having an isocyanuric acid ring.

5. The resin composition of claim 1, wherein a weight proportion of the olefinic resin in the base resin is between 10 wt % and 35 wt %, a weight proportion of the polyphenylene ether resin in the base resin is between 40 wt % and 70 wt %, and a weight proportion of the vinyl copolymer in the base resin is between 20 wt % and 25 wt %.

6. The resin composition of claim 1, further comprising an initiator, wherein a weight proportion of the initiator in the resin composition is between 0.1 wt % and 0.2 wt %.

7. The resin composition of claim 1, further comprising an inorganic filler material, wherein a weight proportion of the inorganic filler material in the resin composition is between 60 wt % and 80 wt %.

8. The resin composition of claim 1, wherein a weight proportion of the polyphenylene ether resin in the base resin is greater than a weight proportion of the olefinic resin in the base resin and a weight proportion of the vinyl copolymer in the base resin.

9. The resin composition of claim 1, wherein a sum of a weight proportion of the polyphenylene ether resin in the base resin, a weight proportion of the vinyl copolymer in the base resin, and a weight proportion of the olefinic resin in the base resin is 100 wt %.

10. The resin composition of claim 1, wherein a usage amount of the hardened resin in the resin composition is greater than a usage amount of the olefinic resin in the resin composition.
